(19) United States
(12) Patent Application Publication
(10) Pub. No.: US 2013/0016649 A1
(43) Pub. Date: Jan. 17, 2013

(54) SYSTEM DESIGN FOR USER EQUIPMENT RELAYS

(71) Applicants: Aleksandar Damnjanovic, Del Mar, CA (US); Naga Bhushan, San Diego, CA (US); Saiyiu D. Ho, San Diego, CA (US); Yongbin Wei, San Diego, CA (US); Durga Prasad Malladi, San Diego, CA (US)

(72) Inventors: Aleksandar Damnjanovic, Del Mar, CA (US); Naga Bhushan, San Diego, CA (US); Saiyiu D. Ho, San Diego, CA (US); Yongbin Wei, San Diego, CA (US); Durga Prasad Malladi, San Diego, CA (US)

(73) Assignee: QUALCOMM INCORPORATED, San Diego, CA (US)

(21) Appl. No.: 13/546,970

(22) Filed: Jul. 11, 2012

Related U.S. Application Data
(60) Provisional application No. 61/506,985, filed on Jul. 12, 2011.

(51) Int. Cl. H04W 88/04

(52) U.S. Cl. 370/315

(57) ABSTRACT

Certain aspects of the present disclosure provide methods and apparatus related to various considerations for using systems comprising user equipment (UE) relays. One method generally includes receiving, at a UE functioning as a relay, data from a first apparatus; and relaying the received data to a second apparatus, wherein the relaying does not involve interpreting or altering security features of the received data.

### CROSS-REFERENCE TO RELATED APPLICATIONS

This application claims benefit of priority to U.S. Provisional Application Ser. No. 61/506,985, filed on Jul. 12, 2011, which is expressly incorporated by reference herein in its entirety.

### BACKGROUND

1. Field

Certain aspects of the disclosure generally relate to wireless communications and, more particularly, to various system considerations for using user equipment (UE) devices functioning as relays.

2. Background

Wireless communication networks are widely deployed to provide various communication services such as voice, video, packet data, messaging, broadcast, etc. These wireless networks may be multiple-access networks capable of supporting multiple users by sharing the available network resources (e.g., bandwidth and transmit power). Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication with a number of user equipment devices (UEs). A UE may communicate with a base station via the downlink and uplink. The downlink (or forward link) refers to the communication link from the base station to the UE, and the uplink (or reverse link) refers to the communication link from the UE to the base station. A base station may transmit data and control information on the downlink to a UE and/or may receive data and control information on the uplink from the UE. This communication link may be established via a single-input single-output, multiple-input single-output or a multiple-input multiple-output (MIMO) system.

Wireless communication systems may comprise a donor base station that communicates with wireless terminals via a relay node, such as a relay base station. The relay node may communicate with the donor base station via a backhaul link and with the terminals via an access link. In other words, the relay node may receive downlink messages from the donor base station over the backhaul link and relay these messages to the terminals over the access link. Similarly, the relay node may receive uplink messages from the terminals over the access link and relay these messages to the donor base station over the backhaul link. The relay node may, thus, be used to supplement a coverage area and help fill “coverage holes.”

### SUMMARY

Certain aspects of the present disclosure generally relate to various design considerations for utilizing user equipments (UEs) as relays.

Certain aspects of the present disclosure provide a method for wireless communications. The method generally includes receiving, at a first user equipment (UE) functioning as a relay, data from a first apparatus; and relaying the received data to a second apparatus without interpreting or altering security features of the received data.

In an aspect of the disclosure, a first UE functioning as a relay for wireless communications is provided. The first UE generally includes a receiver configured to receive data from a first apparatus and a transmitter configured to relay the received data to a second apparatus without interpreting or altering security features of the received data.

In an aspect of the disclosure, a first UE functioning as a relay for wireless communications is provided. The first UE generally includes means for receiving data from a first apparatus and means for relaying the received data to a second apparatus without interpreting or altering security features of the received data.

In an aspect of the disclosure, a computer-program product for wireless communications is provided. The computer-program product generally includes a computer-readable medium having code for receiving, at a first UE functioning as a relay, data from a first apparatus and for relaying the received data to a second apparatus without interpreting or altering security features of the received data.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates an example wireless communication system according to an aspect of the present disclosure.

FIG. 2 is a block diagram conceptually illustrating an example of a Node B in communication with a user equipment device (UE) in a wireless communication system, according to an aspect of the present disclosure.

FIG. 3 illustrates an example wireless communications system with a relay UE according to an aspect of the present disclosure.

FIG. 4 illustrates an example protocol stack for wireless communications via a relay UE, with end-to-end communications above a Radio Link Control (RLC) layer, according to an aspect of the present disclosure.

FIG. 5 illustrates an example protocol stack for wireless communications via a relay UE, with partial Radio Resource Control (RRC) functionality at the relay UE, according to an aspect of the present disclosure.

FIG. 6 is a system block diagram of an example relay UE deployment scenario with carrier aggregation, according to an aspect of the present disclosure.

FIG. 7 is a system block diagram of an example relay UE deployment scenario with carrier-aggregation-like features, according to an aspect of the present disclosure.

FIG. 8 is a system block diagram of an example single-carrier-aggregation-like relay UE deployment scenario, according to an aspect of the present disclosure.

FIG. 9 is a system block diagram of an example single-carrier-mode relay UE deployment scenario, according to an aspect of the present disclosure.

FIG. 10 is a call flow involving a relay UE for carrier aggregation mode, according to an aspect of the present disclosure.

FIG. 11 is a call flow involving a relay UE for non-carrier-aggregation mode, according to an aspect of the present disclosure.

FIG. 12 is a flow diagram of example operations for relaying data from the perspective of a UE relay, for example, according to an aspect of the present disclosure.

FIG. 13 is a call flow illustrating initial access of a relay UE with a base station in a single carrier mode, according to aspects of the present disclosure.

FIG. 14 is a call flow illustrating handover of a terminal UE between relay UEs served by a common base station, according to aspects of the present disclosure.

FIG. 15 is a call flow illustrating handover of a terminal UE between relay UEs served by different base stations, according to aspects of the present disclosure.

FIG. 16 is a call flow illustrating handover of a relay UE between different base stations, according to aspects of the present disclosure.

FIG. 17 is a call flow illustrating handover of a terminal UE from a relay UE to a first base station and handover of the relay UE from the first base station to a second base station, according to aspects of the present disclosure.

FIG. 18 is a call flow illustrating handover of a relay UE from a first base station to a second base station and handover of a terminal UE from the relay UE to the second base station, according to aspects of the present disclosure.

FIG. 19 is a call flow illustrating handover of a terminal UE from a first base station to a relay UE, according to aspects of the present disclosure.

FIG. 20 is a call flow illustrating initial access of a relay UE with a base station in a carrier aggregation mode, according to aspects of the present disclosure.

FIG. 21 is a call flow illustrating handover of a terminal UE between relay UEs served by a common base station in a carrier aggregation mode, according to aspects of the present disclosure.

FIG. 22 is a call flow illustrating handover of a terminal UE between relay UEs served by different base stations in a carrier aggregation mode, according to aspects of the present disclosure.

FIG. 23 is a call flow illustrating handover of a relay UE between different base stations in a carrier aggregation mode, according to aspects of the present disclosure.

### DESCRIPTION

Certain aspects of the present disclosure generally relate to various design considerations for utilizing user equipments (UEs) as relays between a base station (e.g., an evolved Node B or eNB) and other UEs, referred to herein as terminal UEs (or destination UEs).

For certain aspects, UE relays may serve as a simple data pipe and may not be involved in radio resource control (RRC) state control of the terminal UEs. For example, signals received by the UE relay from the eNB may be sent directly to the destination UE without any signal modification, such that the UE relay may seem transparent to a terminal UE.

Utilizing UE relays in this manner to relay data traffic from a base station (e.g., an evolved Node B or eNB) to other UEs, referred to herein as terminal UEs (or destination UEs) presents a number of design challenges.

For example, due to mobility of both terminal UEs and relay UEs, a number of different handover scenarios may be encountered. These example handover scenarios include handover of a terminal UE between relay UEs (served by the same eNB or different eNBs), handover of a terminal UE between a relay UE and eNB, and handover of a relay UE between different eNBs.

Techniques of the present disclosure provide techniques for addressing various such issues encountered when utilizing relay UEs in a relatively transparent manner.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

### An Example Wireless Communication System

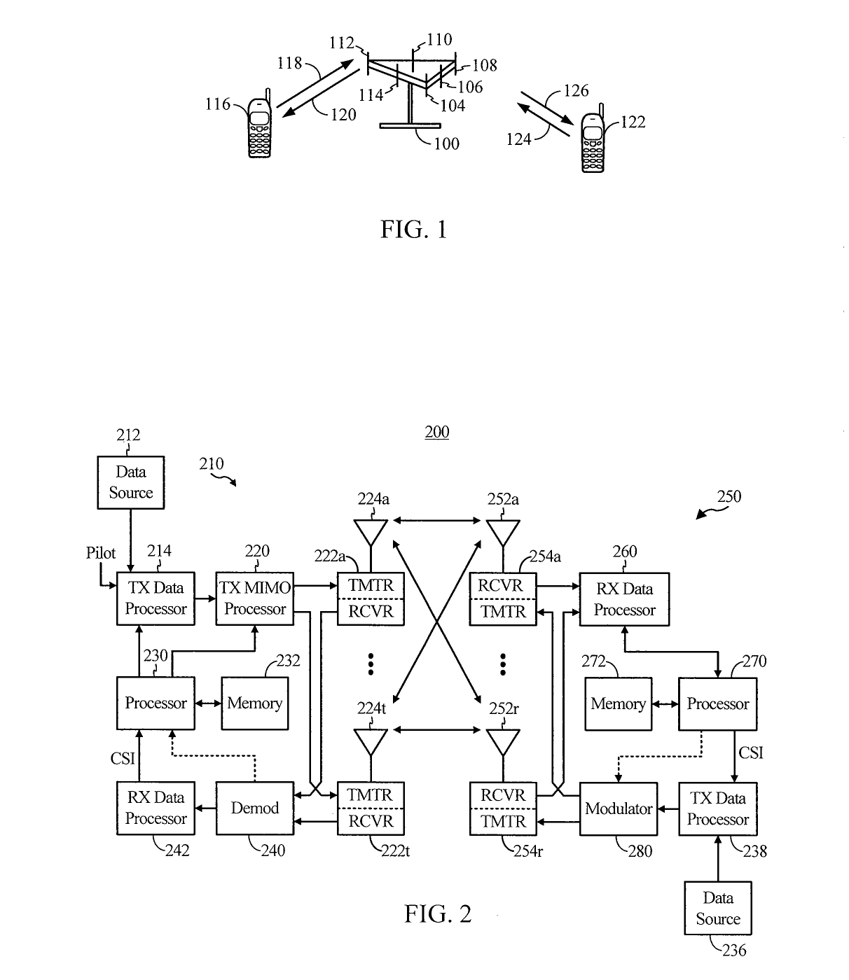

Referring to FIG. 1, a multiple access wireless communication system according to one embodiment is illustrated. An access point 100 (AP) includes multiple antenna groups, one including antenna 104 and antenna 106, another including antenna 108 and antenna 110, and yet another including antenna 112 and antenna 114. In FIG. 1, only two antennas are shown for each antenna group; however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124, and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio (SNR) of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point (AP) may be a fixed station used for communicating with the terminals and may also be referred to as a base station (BS), a Node B, or some other terminology. An access terminal may also be called a mobile station (MS), user equipment (UE), a wireless communication device, terminal, user terminal (UT), or some other terminology.

FIG. 2 is a block diagram of an embodiment of a transmitter system 210 (also known as an access point) and a receiver system 250 (also known as an access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH) which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Scheduling Request (SR), a Physical Uplink Shared Channel (PUSCH), and a plurality of PHY channels. The PHY channels comprise a set of DL channels and UL channels.

In an aspect, a channel structure is provided that preserves low PAR (at any given time, the channel is contiguous or uniformly spaced in frequency) properties of a single carrier waveform.

For the purposes of the present document, the following abbreviations (including abbreviations for various DL and UL PHY Channels) apply:
1xCSFB Circuit Switched Fallback to 1xRTT
ABS Almost Blank Subframe
ACK Acknowledgement
ACLR Adjacent Channel Leakage Ratio
AM Acknowledged Mode
AMBR Aggregate Maximum Bit Rate
ANR Automatic Neighbour Relation
ARQ Automatic Repeat Request
ARP Allocation and Retention Priority
AS Access Stratum
BCCH Broadcast Control Channel
BCH Broadcast Channel
BSR Buffer Status Report
C/I Carrier-to-Interference Power Ratio
CAZAC Constant Amplitude Zero Auto-Correlation
CA Carrier Aggregation
CBC Cell Broadcast Center
CC Component Carrier
CIF Carrier Indicator Field
CMAS Commercial Mobile Alert Service
CMC Connection Mobility Control
CP Cyclic Prefix
C-plane Control Plane
C-RNTI Cell RNTI
CQI Channel Quality Indicator
CRC Cyclic Redundancy Check
CSA Common Subframe Allocation
CSG Closed Subscriber Group
DCCH Dedicated Control Channel
DeNB Donor eNB
DFTS DFT Spread OFDM
DL Downlink
DRB Data Radio Bearer
DRX Discontinuous Reception
DTCH Dedicated Traffic Channel
DTX Discontinuous Transmission
DwPTS Downlink Pilot Time Slot
ECGI E-UTRAN Cell Global Identifier
ECM EPS Connection Management
EMM EPS Mobility Management
E-CID Enhanced Cell-ID (positioning method)
eNB E-UTRAN NodeB
EPC Evolved Packet Core
EPS Evolved Packet System
E-RAB E-UTRAN Radio Access Bearer
ETWS Earthquake and Tsunami Warning System
E-UTRA Evolved UTRA
E-UTRAN Evolved UTRAN
FDD Frequency Division Duplex
FDM Frequency Division Multiplexing
GERAN GSM EDGE Radio Access Network
GNSS Global Navigation Satellite System
GSM Global System for Mobile communication
GBR Guaranteed Bit Rate
GP Guard Period
HARQ Hybrid ARQ
HO Handover
HRPD High Rate Packet Data
HSDPA High Speed Downlink Packet Access
ICIC Inter-Cell Interference Coordination
IP Internet Protocol
LB Load Balancing
LCG Logical Channel Group
LCR Low Chip Rate
LCS LoCation Service
LIPA Local IP Access
LPPa LTE Positioning Protocol Annex
L-GW Local Gateway
LTE Long Term Evolution
MAC Medium Access Control
MBMS Multimedia Broadcast Multicast Service
MBR Maximum Bit Rate
MBSFN Multimedia Broadcast multicast service Single Frequency Network
MCCH Multicast Control Channel
MCE Multi-cell/multicast Coordination Entity
MCH Multicast Channel
MCS Modulation and Coding Scheme
MDT Minimization of Drive Tests
MIB Master Information Block
MIMO Multiple Input Multiple Output
MME Mobility Management Entity
MSA MCH Subframe Allocation
MSI MCH Scheduling Information
MSP MCH Scheduling Period
MTCH Multicast Traffic Channel
NACK Negative Acknowledgement
NAS Non-Access Stratum
NCC Next Hop Chaining Counter
NH Next Hop key
NNSF NAS Node Selection Function
NR Neighbour cell Relation
NRT Neighbour Relation Table
OFDM Orthogonal Frequency Division Multiplexing
OFDMA Orthogonal Frequency Division Multiple Access
OTDOA Observed Time Difference Of Arrival (positioning method)
P-GW PDN Gateway
P-RNTI Paging RNTI
PA Power Amplifier
PAPR Peak-to-Average Power Ratio
PBCH Physical Broadcast CHannel
PBR Prioritised Bit Rate
PCC Primary Component Carrier
PCCH Paging Control Channel
PCell Primary Cell
PCFICH Physical Control Format Indicator CHannel
PCH Paging Channel
PCI Physical Cell Identifier
PDCCH Physical Downlink Control CHannel
PDSCH Physical Downlink Shared CHannel
PDCP Packet Data Convergence Protocol
PDN Packet Data Network
PDU Protocol Data Unit
PHICH Physical Hybrid ARQ Indicator CHannel
PHY Physical layer
PLMN Public Land Mobile Network
PMCH Physical Multicast CHannel
PRACH Physical Random Access CHannel
PRB Physical Resource Block
PSC Packet Scheduling
PUCCH Physical Uplink Control CHannel
PUSCH Physical Uplink Shared CHannel
PWS Public Warning System
QAM Quadrature Amplitude Modulation
QCI QoS Class Identifier
QoS Quality of Service
RA-RNTI Random Access RNTI
RAC Radio Admission Control
RACH Random Access Channel
RAT Radio Access Technology
RB Radio Bearer
RBC Radio Bearer Control
RF Radio Frequency
RIM RAN Information Management
RLC Radio Link Control
RN Relay Node
RNC Radio Network Controller
RNL Radio Network Layer
RNTI Radio Network Temporary Identifier
ROHC Robust Header Compression
RRC Radio Resource Control
RRM Radio Resource Management
RU Resource Unit
S-GW Serving Gateway
S1-MME S1 for the control plane
SCC Secondary Component Carrier
SCell Secondary Cell
SI System Information
SIB System Information Block
SI-RNTI System Information RNTI
S1-U S1 for the user plane
SAE System Architecture Evolution
SAP Service Access Point
SC-FDMA Single Carrier-Frequency Division Multiple Access
SCH Synchronization Channel
SDF Service Data Flow
SDMA Spatial Division Multiple Access
SDU Service Data Unit
SeGW Security Gateway
SFN System Frame Number
SPID Subscriber Profile ID for RAT/Frequency Priority
SR Scheduling Request
SRB Signalling Radio Bearer
SU Scheduling Unit
TA Tracking Area
TB Transport Block
TCP Transmission Control Protocol
TDD Time Division Duplex
TEID Tunnel Endpoint Identifier
TFT Traffic Flow Template
TM Transparent Mode
TNL Transport Network Layer
TTI Transmission Time Interval
UE User Equipment
UL Uplink
UM Unacknowledged Mode
UMTS Universal Mobile Telecommunication System
U-plane User plane
UTRA Universal Terrestrial Radio Access
UTRAN Universal Terrestrial Radio Access Network
UpPTS Uplink Pilot Time Slot
VRB Virtual Resource Block
X2-C X2-Control plane
X2-U X2-User plane

### An Example Relay System

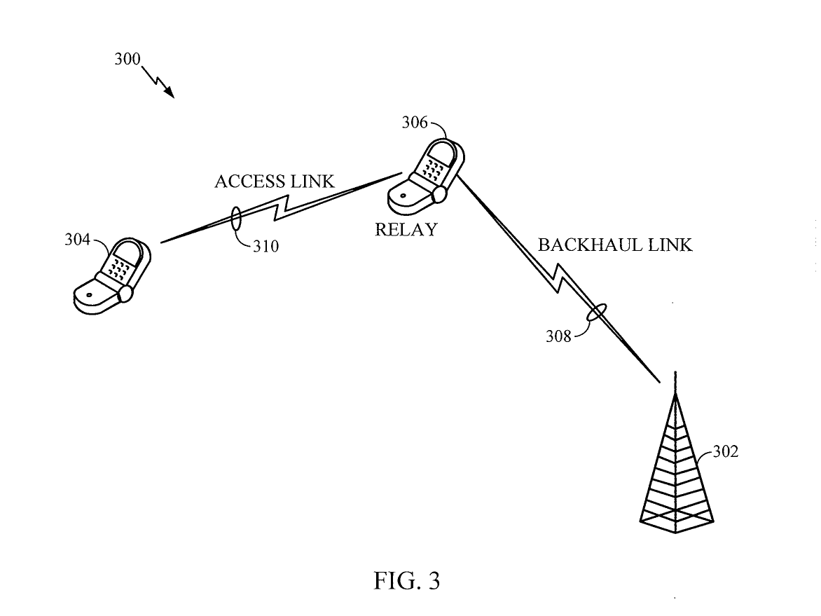

FIG. 3 illustrates an example wireless system 300 in which certain aspects of the present disclosure may be practiced. As illustrated, the system 300 includes a donor base station (BS) 302 (also known as donor access point or a donor evolved Node B (DeNB)) that communicates with a user equipment (UE) 304 via a relay node 306 (also known as a relay station or a relay). While the relay node 306 may comprise a relay base station (also known as a relay eNB), a UE (e.g., a cell phone) may also function as a relay for relaying transmissions for other UEs, as shown in FIG. 3. Such relays may be known as relay UEs, UE relays, or UEs functioning as relays.

The relay node 306 may communicate with the donor BS 302 via a backhaul link 308 and with the UE 304 via an access link 310. In other words, the relay node 306 may receive downlink messages from the donor BS 302 over the backhaul link 308 and relay these messages to the UE 304 over the access link 310. Similarly, the relay node 306 may receive uplink messages from the UE 304 over the access link 310 and relay these messages to the donor BS 302 over the backhaul link 308. In this manner, the relay node 306 may, thus, be used to supplement a coverage area and help fill “coverage holes.”

### Example System Design for L2 UE Relays

As described above, the relay node 306 may comprise a UE relay. UE relays are UEs capable of relaying data traffic from an evolved Node B (eNB) to other UEs, known as terminal UEs or destination UEs. For certain aspects, UE relays may serve as a simple data pipe and may not be involved in radio resource control (RRC) state control of the terminal UEs. For example, signals received by the UE relay from the eNB may be sent directly to the destination UE without any signal modification, such that the UE relay may seem transparent to the destination UE. Furthermore, UE relays may provide unrestricted access therethrough. More specifically, a UE relay may not be involved with security in any way, and a UE relay may only be aware of the PHY/MAC/RLC configuration of the terminal UE to which the UE relay relays data traffic.

A UE relay may connect to an eNB as a regular UE (i.e., a UE without relay capability). In establishing this connection, the UE relay may be made aware of the physical (PHY), media access control (MAC), and the radio link control (RLC) configurations of the destination UE being served by the UE relay. This awareness may allow the UE relay to schedule traffic to the destination UE. This PHY/MAC/RLC configuration may be conveyed through RRC or higher layer signaling, which may involve new information elements (IEs) and information for each destination UE served by the UE relay. The RLC protocol termination points are the eNB and the destination UE; the UE relay may only implement segmentation and concatenation (i.e., reassembly) functionality of RLC.

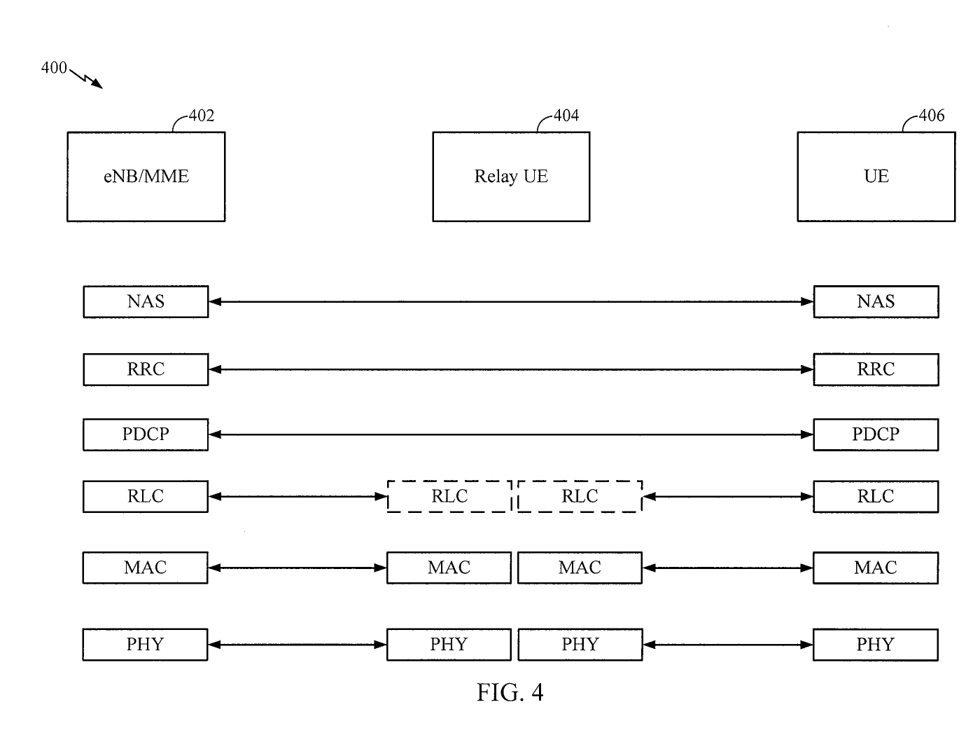

FIG. 4 illustrates an example protocol stack 400 supporting the features and functionality of a UE relay as described above. In this protocol stack 400, the MAC layer is disposed above the PHY layer, and the RLC layer is disposed above the MAC layer. The Non-Access Stratum (NAS), RRC, and Packet Data Convergence Protocol (PDCP) layers are all end-to-end between the eNB/MME 402 and the terminal UE 406 without interception by the UE relay. Because PDCP provides security (e.g., ciphering) of user data, it may be desirable to keep PDCP end-to-end so user data of the UE is ciphered end-to-end and, thus, cannot be eavesdropped by the relay UE 404.

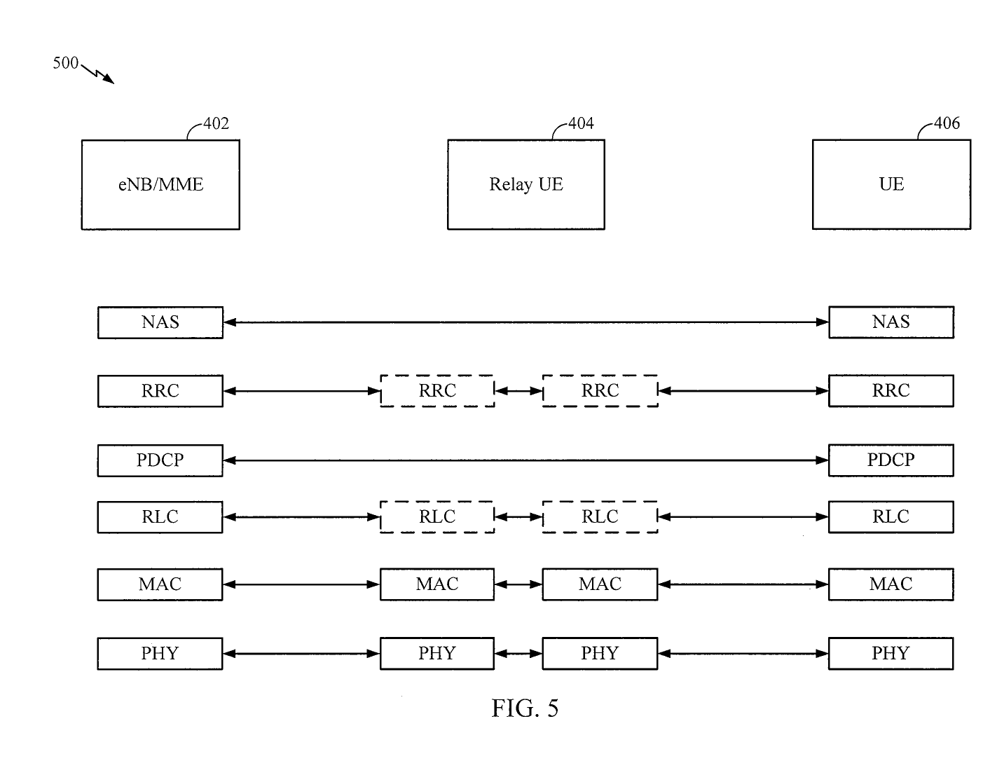

FIG. 5 illustrates another example protocol stack 500 with partial RRC functionality at the relay UE 404. With this optional protocol stack 500, the relay UE 404 may independently configure the PHY/MAC/RLC configuration for the access link 310 (i.e., the relay-UE-to-destination-UE link), rather than simply being aware of the PHY/MAC/RLC configuration. In this case, the RRC layer is partially terminated at the relay UE 404. However, the relay UE may not be involved in RRC state control.

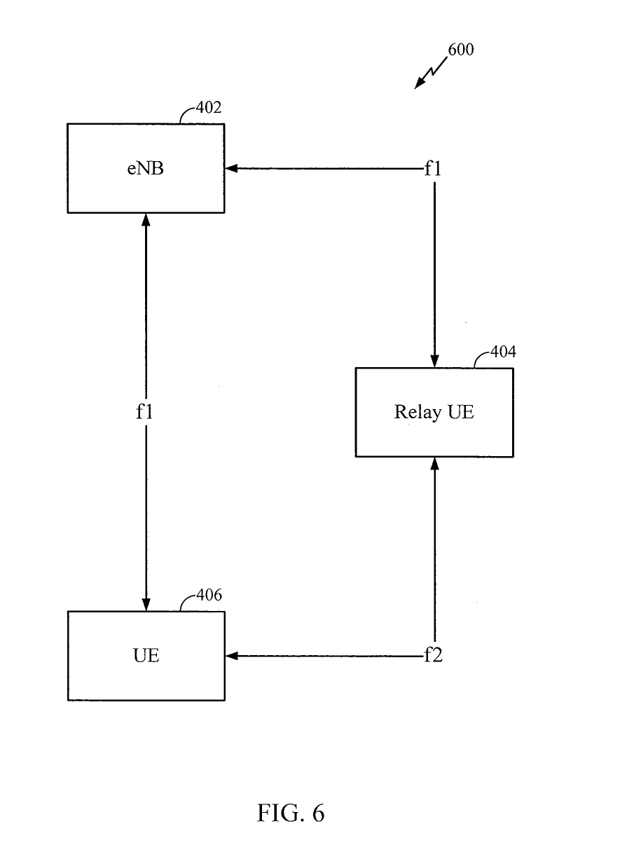

Various options exist for deploying relay UEs to relay data between terminal UEs and eNBs. For example, the relay UE may maintain the only direct connection with the terminal UE or the terminal UE may also maintain a direct connection with the eNB. Further, relay UEs may be deployed in single carrier systems or systems utilizing carrier aggregation. In such systems, a terminal UE may be served by an eNB on a first frequency (e.g., a primary component carrier or PCC), while the terminal U E is served by a relay UE on a second frequency (e.g., a secondary component carrier or SCC). FIGS. 6-9 illustrate examples of such deployment options.

FIG. 6 is a system block diagram 600 of an example relay UE deployment scenario with carrier aggregation, according to an aspect of the present disclosure. With carrier aggregation, the primary component carrier (PCC) may be on f1, and the secondary component carrier (SCC) may be on f2. As illustrated, the terminal UE 406 may be served on carrier frequency f1 by the eNB 402. However, the terminal UE 406 may be served by the relay UE 404 on carrier frequency f2 as shown. For certain aspects, f1 may be in the licensed spectrum, while f2 may be in the unlicensed spectrum, such that traffic may be offloaded to the unlicensed spectrum via the relay UE 404.

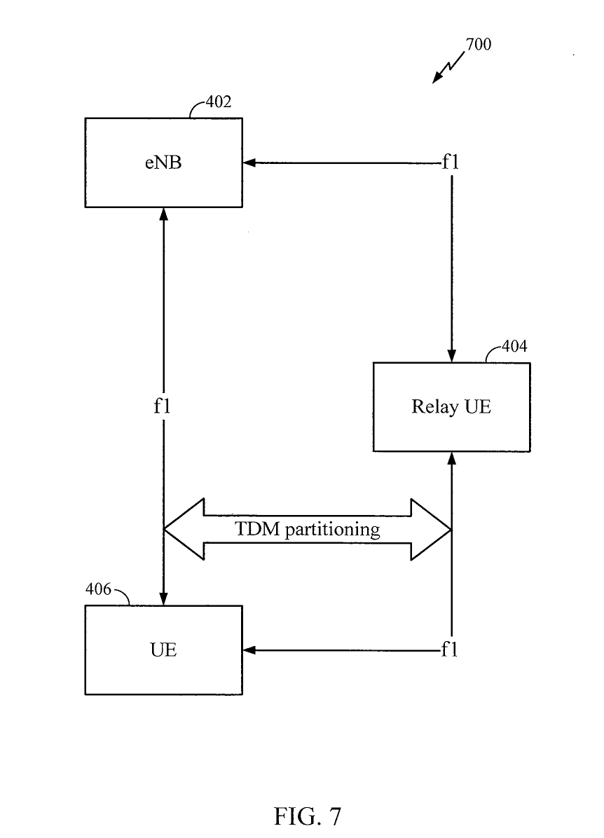

FIG. 7 is a system block diagram 700 of an example relay UE deployment scenario with carrier-aggregation-like features, according to an aspect of the present disclosure. In this deployment scenario, PCC may be on f1, and the SCC may also be on f1. The terminal UE 406 may be served on carrier frequency f1 by the eNB 402 and/or the relay UE 404. Time domain multiplexing (TDM) partitioning may be employed to avoid simultaneous reception at the UE 406. Utilizing TDM in this manner, the UE may be either receiving from or transmitting to either the eNB 402 or the relay UE 404.

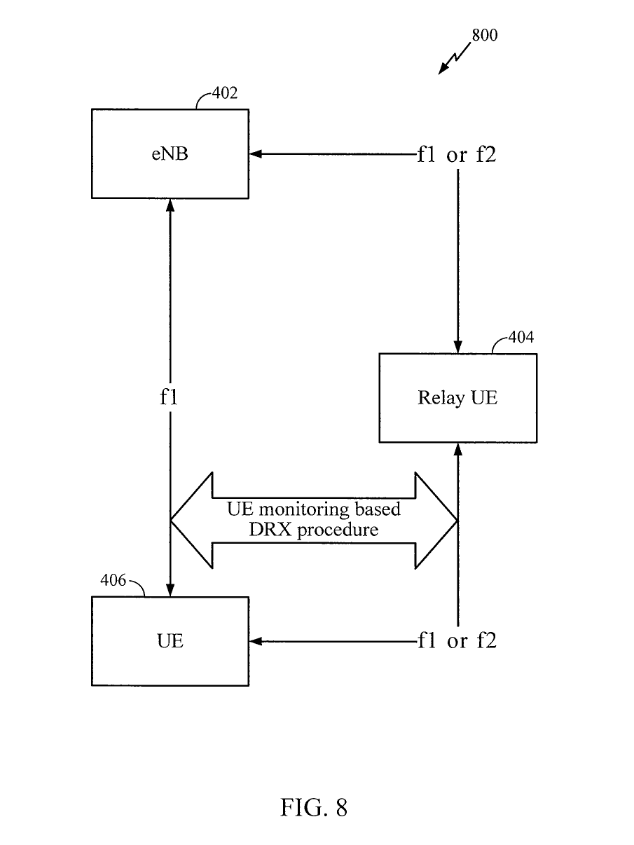

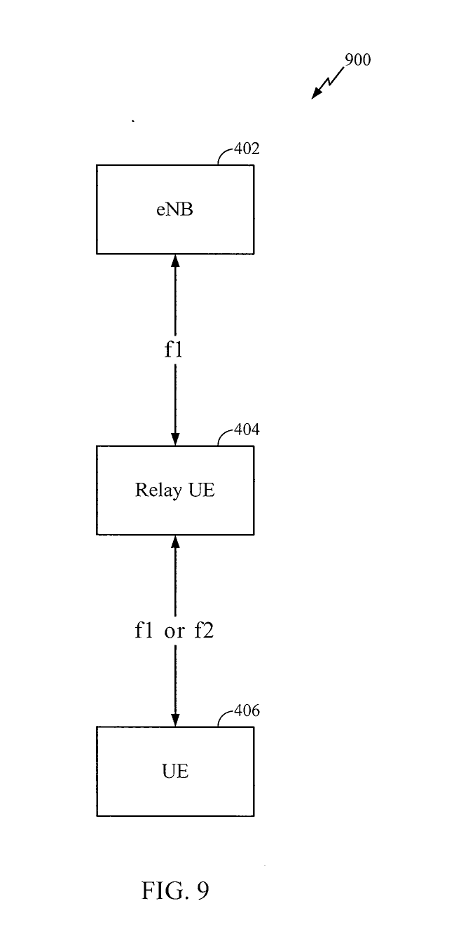

FIG. 8 is a system block diagram 800 of an example single-carrier-aggregation-like relay UE deployment scenario, according to an aspect of the present disclosure. As illustrated, terminal UE 406 may communicate with the eNB exclusively on f1, while the relay UE 404 may communicate with the eNB 402 and terminal UE 406 via f1 and/or f2.

In this deployment scenario, the UE 406 may monitor the eNB 402 based on active (or on periods) of a discontinuous reception (DRX) procedure. During off periods, the UE may monitor the relay UE 404 instead. In this scenario, the terminal UE 406 may send or receive traffic from either the eNB 402 or the relay UE 404.

MAC signaling may be utilized to signal link change or flow control. For example a MAC signal may be sent from the eNB 402 to the relay UE 404 to activate/deactivate scheduling of traffic to the UE 406. Similarly, the relay UE 404 may send a MAC signal to the eNB 402 for the eNB to stop scheduling traffic to the relay UE. This instruction may possibly be for a given set of UEs 406. As another example, a MAC signal may be sent from the relay UE 404 to the UE 406 instructing the UE to tune to the eNB 402. Likewise, the eNB 402 may send a MAC signal to the UE 406 instructing the UE to monitor the relay UE 404. In addition, the UE 406 may send a MAC signal to the relay UE 404 instructing the relay UE to stop scheduling traffic to the UE 406 (or a set of terminal UEs). This may occur, for example, due to the start of monitoring the direct eNB link.

FIG. 9 is a system block diagram 900 of an example single-carrier-mode relay UE deployment scenario, according to an aspect of the present disclosure. As illustrated, the relay UE 404 may communicate with the eNB 402 via f1 exclusively and with the terminal UE 406 via f1 and/or f2.

In this deployment scenario, the UE 406 has access through the relay UE 404 only, with no direct communication with the eNB 402. In this case, there may be tunneling of signaling radio bearers through the relay UE 404. To maintain transparency, the relay UE may be involved in allowing the UE 406 access and mutual authentication.

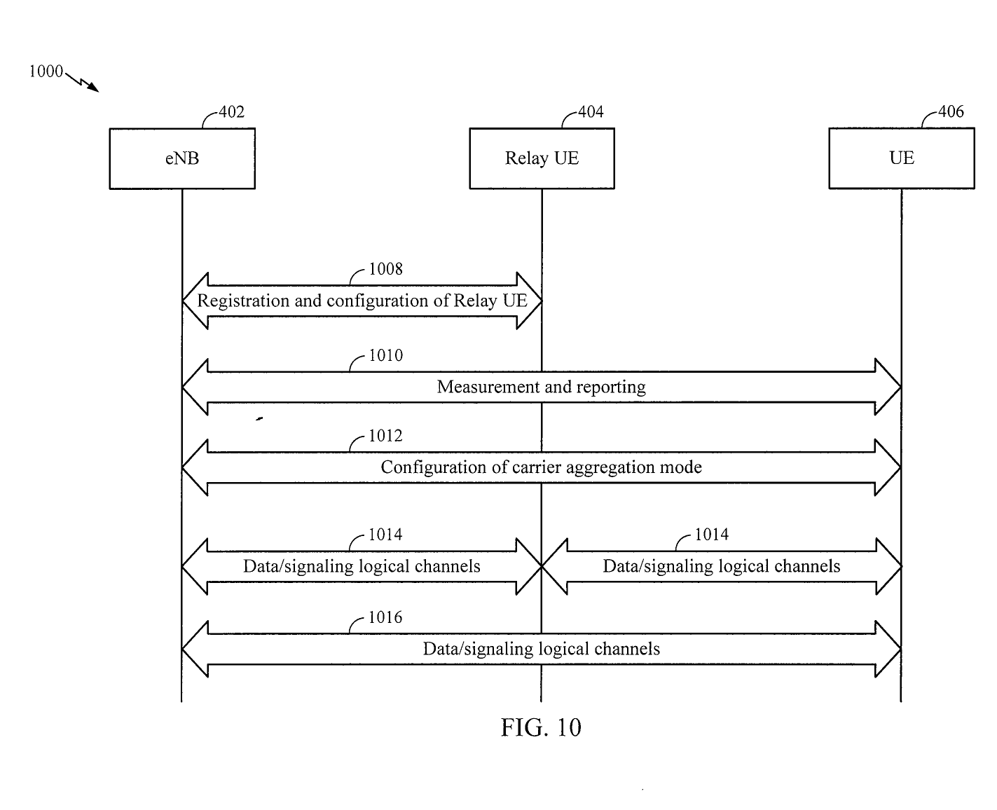

FIG. 10 is a call flow 1000 illustrating what may be considered a baseline procedure for a carrier aggregation mode utilizing a relay UE, according to an aspect of the present disclosure.

At 1008, the relay UE 404 may perform the initial attach procedure as an ordinary UE (i.e., a UE without relay capability). The relay UE may then register with the eNB as a relay. This registration may be performed based on some criteria, such as measured reference signal received quality (RSRQ) and/or proximity detection of other UEs, loading measure (such as utilized physical resource blocks, etc.) or other criteria. Almost anything may trigger the relay UE to register as a relay with the eNB. The eNB 402 may also configure the relay UE 404 to schedule data traffic for configured radio bearers for configured UEs. There may be different modes of routing traffic, but there is always a logical (virtual) connection between the UE 406 and the eNB 402.

At 1010, terminal UE 406 may perform measurements (e.g., of relay UE 404 and eNB 402) and report back to eNB 402. At 1012, carrier aggregation mode may be configured for certain aspects. In carrier aggregation mode, radio bearers may terminate at the eNB 402 and the UE 406 for eNB-to-UE connection, other than relay UE signaling traffic. Logical channels may terminate at the relay UE 404 (as shown at 1014) or may be end-to-end (as shown at 1016).

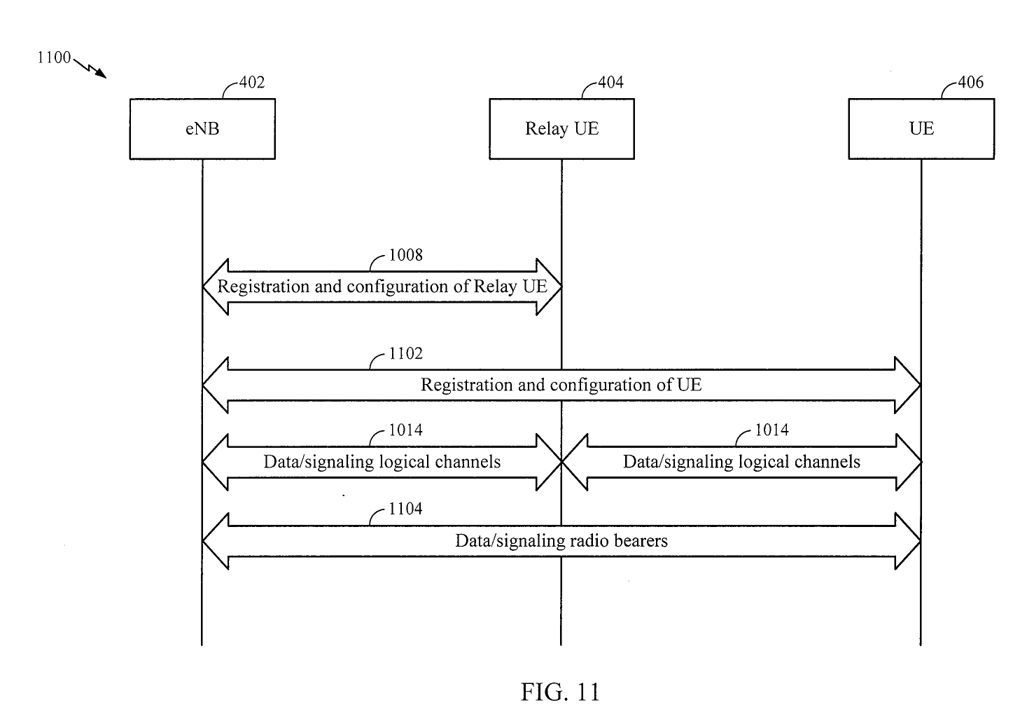

FIG. 11 is a call flow 1100 illustrating a baseline procedure for a non-carrier-aggregation mode, according to an aspect of the present disclosure. At 1102, the UE 406 may registered with and be configured by the eNB 402. With this procedure for a non-carrier-aggregation mode, radio bearers may terminate at the eNB 402 and the UE 406 for eNB-to-UE connection as illustrated at 1104, other than relay UE signaling traffic. Logical channels terminate at the relay UE, as shown at 1014.

To support the aforementioned system considerations for L2 UE relays, changes to current standards (e.g., present LTE standards) may be desired or required. For example, in the RRC (or higher) layer, signaling support may be added for registration and configuration of a relay UE, the potential mapping of radio bearers onto carrier frequencies (e.g., when RLC is not end-to-end between the eNB and the UE), tunneling of UE traffic on the backhaul link, and PHY/MAC/RLC configuration changes.

For the RLC layer, support may be added for segmentation and reassembly of first transmissions at the relay UE (e.g., when RLC is end-to-end between the eNB and the UE). For the MAC layer, there may be changes to the LTE standard in order to support a large number of radio bearers. For example, header changes may be involved in an effort to accommodate radio bearers mapping. In the PHY layer, support may be added for PUCCH on secondary component carriers. This change may help support hybrid automatic repeat-request (HARQ), unless the relay UE can decode PUCCH intended for the eNB.

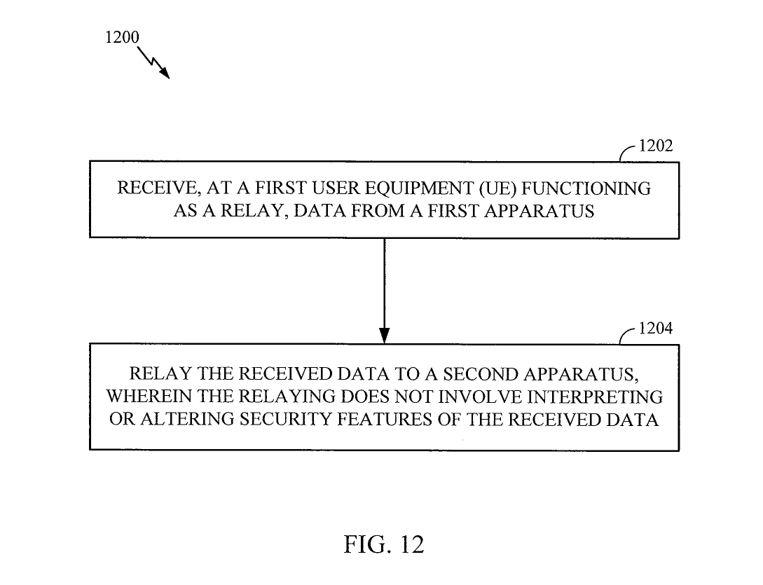

FIG. 12 is a flow diagram of example operations 1200 for relaying data. The operations 1200 may be performed by any type of device acting as a relay, such as relay UE 404 shown in FIGS. 4-9 described above.

The operations begin, at 1202, with a first UE (e.g., a relay UE) receiving data from a first apparatus. At 1204, the first UE may relay the received data to a second apparatus. The relaying at 1204 may be performed without interpreting or altering security features of the data received at 1202.

If the operations 1200 are performed by a relay UE transmitting downlink data, the first apparatus would correspond to an eNB and the second apparatus would correspond to a terminal UE. If the operations 1200 are performed by a relay UE transmitting uplink data, the first apparatus would correspond to the terminal UE and the second apparatus would correspond to the eNB.

According to certain aspects, a protocol stack for the first UE may comprise a physical (PHY) layer, a media access control (MAC) layer disposed above the PHY layer, and a radio link control (RLC) layer disposed above the MAC layer. The relaying may be end-to-end between the first and second apparatuses without interception by the first UE for layers of the protocol stack above the RLC layer. For certain aspects, the first UE is made aware of the PHY/MAC/RLC configuration of the second apparatus. For other aspects, the operations 1200 may further comprise configuring a PHY/MAC/RLC configuration for an access link between the first UE and one of the first and second apparatuses.

As noted above, in some cases, multiple frequencies may be utilized for communicating between the relay UE, eNB, and terminal UE. For example, according to certain aspects, a relay UE may receive data from the first apparatus at 1202 via a first frequency band and may relay the data to the second apparatus via a second frequency band at 1204. One (or both) of the first and second frequency bands may be in an unlicensed spectrum. In some cases, both frequency bands may be in licensed spectrum.

For certain aspects, the first UE may be capable of carrier aggregation. For other aspects, the first UE may support functionality that is similar to carrier aggregation (“carrier-aggregation-like” functionality). In this case, rather than use separate frequencies, the relay UE may perform time division multiplexing (TDM) partitioning with signals sent directly from the first apparatus to the second apparatus in some time slots and signals sent via the UE relay sent in other time slots.

For certain aspects, the first UE may receive, from the first apparatus, a control signal to activate or deactivate the relaying to the second apparatus. For other aspects, the first UE may transmit, to the second apparatus, a control signal directing the second apparatus to tune to the first apparatus. For yet other aspects, the first UE may receive, from the second apparatus, a control signal to stop the relaying to the second apparatus. For still other aspects, the first UE may transmit, to the first apparatus, a control signal directing the first apparatus to stop sending the data to the first UE.

For certain aspects, the first UE may determine a parameter and register with the first apparatus as a relay (e.g., a UE relay), based on the parameter. The parameter may comprise at least one of a reference signal received quality (RSRQ), a proximity of other UEs, or resource loading.

### Example Call Flows for Various Deployment Scenarios

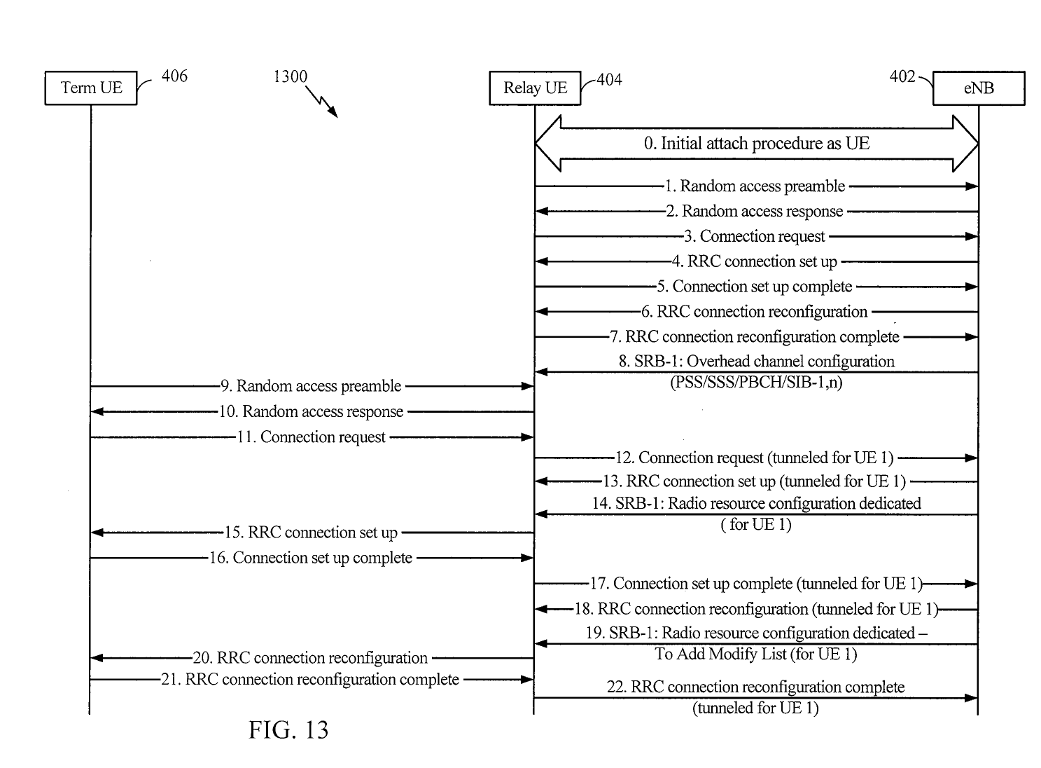

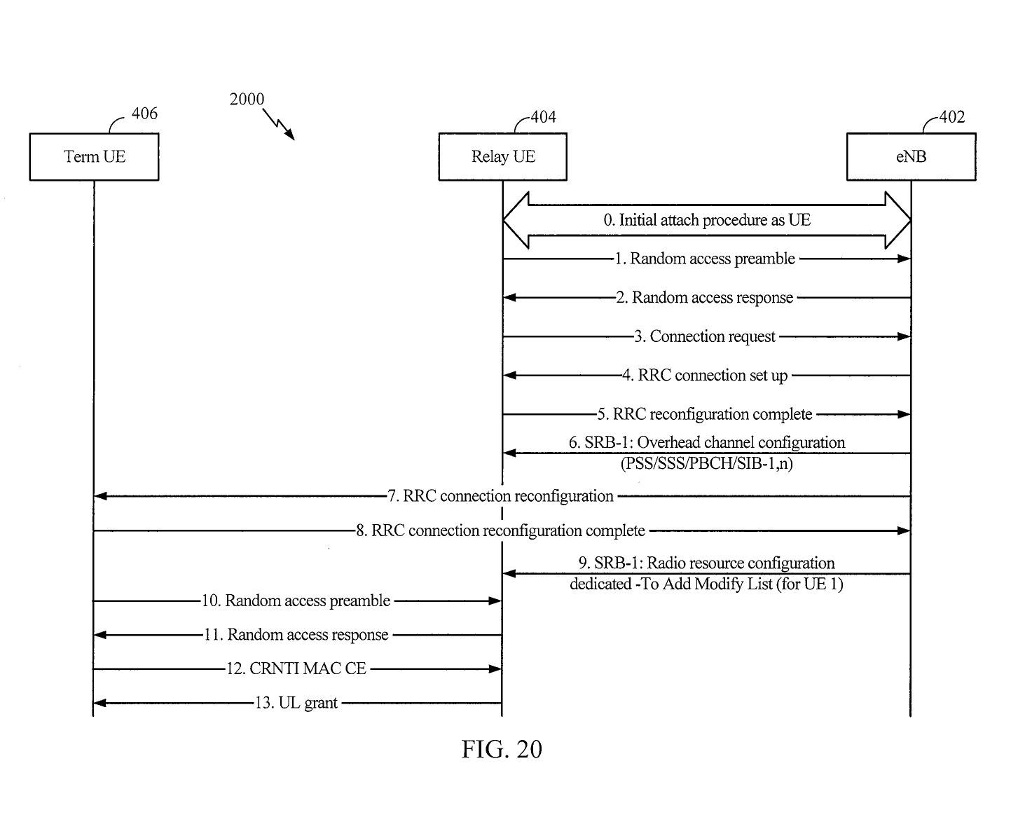

FIGS. 13-23 are call flows illustrating various UE relay deployment scenarios described above, in greater detail. In general, FIGS. 13-19 are calls flows for single carrier mode (e.g., associated with the deployment scenario shown in FIG. 9), while FIGS. 20-23 are call flows for carrier aggregation mode (e.g., corresponding to the deployment scenario in FIG. 6).

FIG. 13 is a call flow 1300 illustrating an example initial access procedure, according to an aspect of the present disclosure. As illustrated, the relay UE 404 may first access eNB 402 as a UE (operations 0-8). Subsequently, rather than access the eNB 402 directly, operations for access performed by terminal UE 406 (e.g., operations 9-11, 15-16, and 20-21) may then be tunneled to eNB 402 via relay UE 404 (operations 12-14, 17-19, and 22).

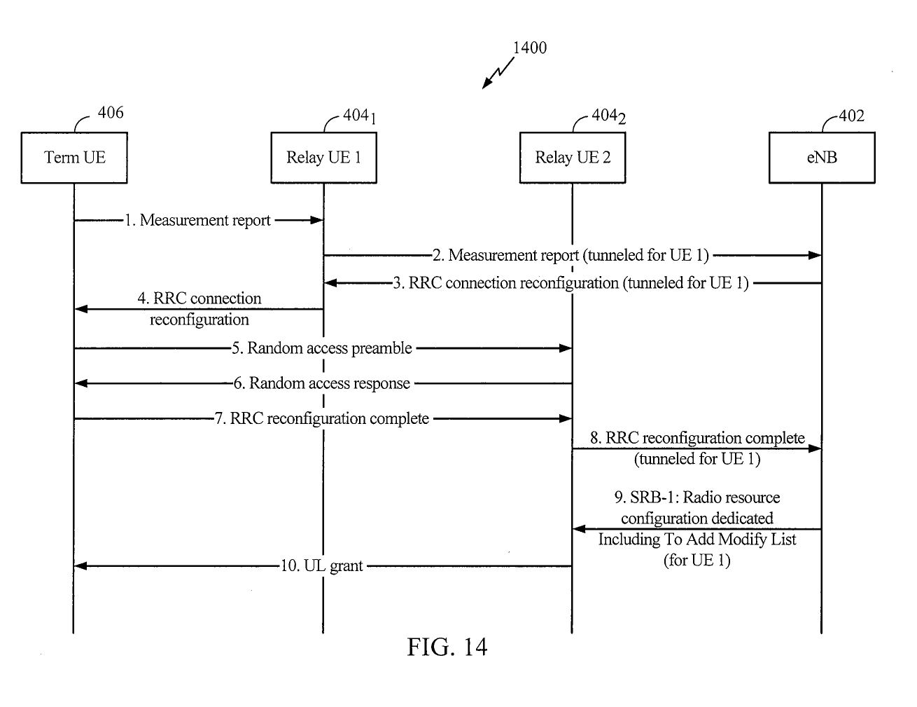

As described above, due to mobility of both terminal UEs and relay UEs, a number of different handover scenarios may be encountered. These example handover scenarios, including handover of a terminal UE between relay UEs (served by the same eNB or different eNBs), handover of a terminal UE between a relay UE and eNB, and handover of a relay UE between different eNBs, are illustrated in FIGS. 14-23.

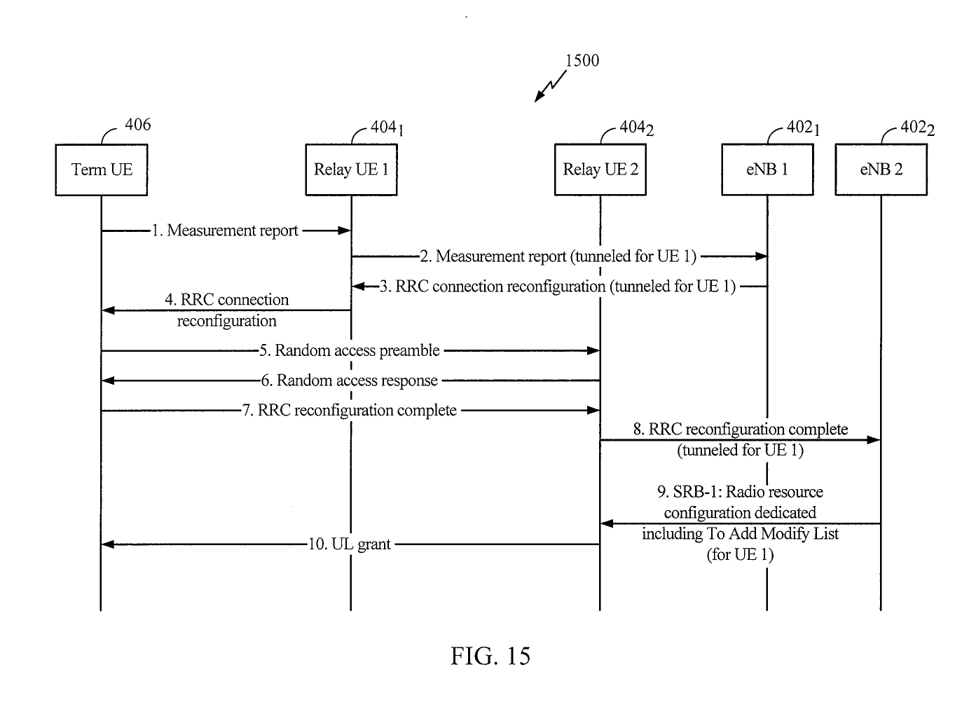

FIG. 14 is a call flow illustrating “backward” handover of terminal UE 406 between relay UEs 404₁ and 404₂, according to aspects of the present disclosure. FIG. 14 illustrates an “intra-eNB” handover where both relay UEs 404₁ and 404₂ are served by the same eNB 402. FIG. 15 illustrates an “inter-eNB” handover where the first relay UE 404₁ is served by a first eNB 402₁ and the second relay UE 404₂ is served by a second eNB 402₂.

As illustrated, in either case, measurements taken by terminal UE 406 (at operation 1) and a corresponding RRC connection reconfiguration message may be tunneled to/from a current serving eNB (at operations 2, 3, and 4), via relay UE 1 404₁. The terminal UE 406 may then perform random access procedures with relay UE2 (operations 5-7) with the RRC reconfiguration complete message tunneled to the eNB at 8. It may be noted that, in FIG. 14, operations 2, 3, 8, and 9 involve the single eNB 402, while in FIG. 15, operations 2 and 3 are performed with eNB 1 serving relay UE 1, while operations 8 and 9 are performed with eNB 2 serving relay UE 2.

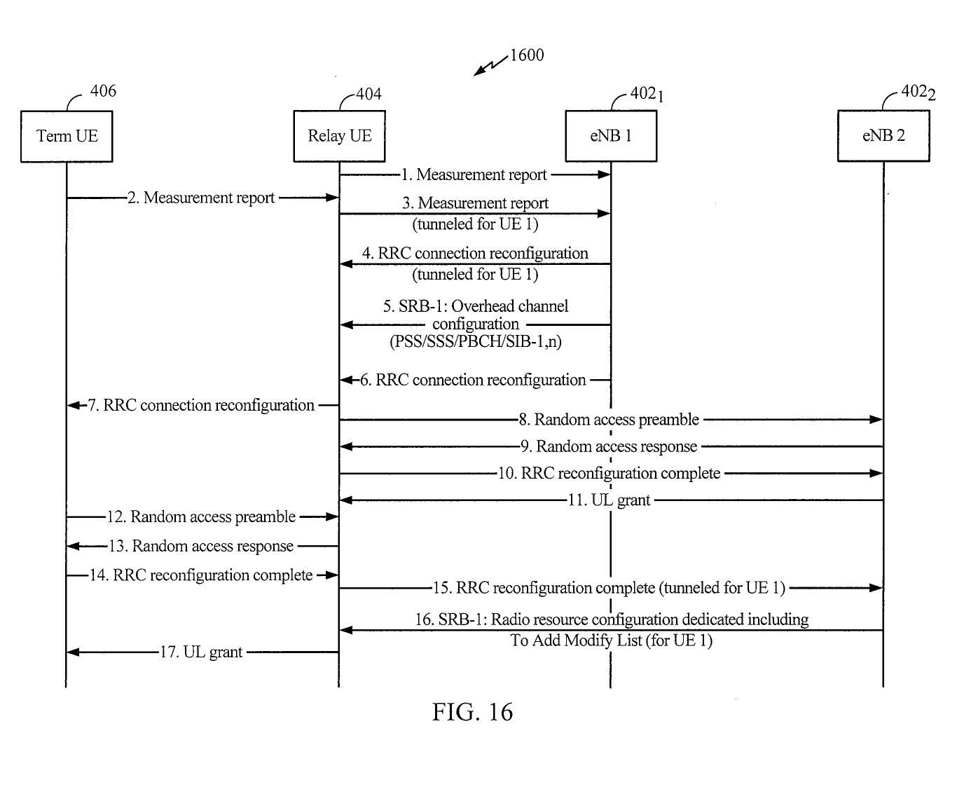

FIG. 16 is a call flow illustrating handover of a relay UE between different base stations, according to aspects of the present disclosure. In this example, relay UE 404 is handed over from a first eNB 402₁ to the second eNB 402₂. While the UE 406 is served by the same relay UE 404 (before and after handover of relay UE 404), to maintain transparency, an RRC connection reconfiguration message is sent (at 7), as if the UE 1, itself, were handed over from eNB1 to eNB2.

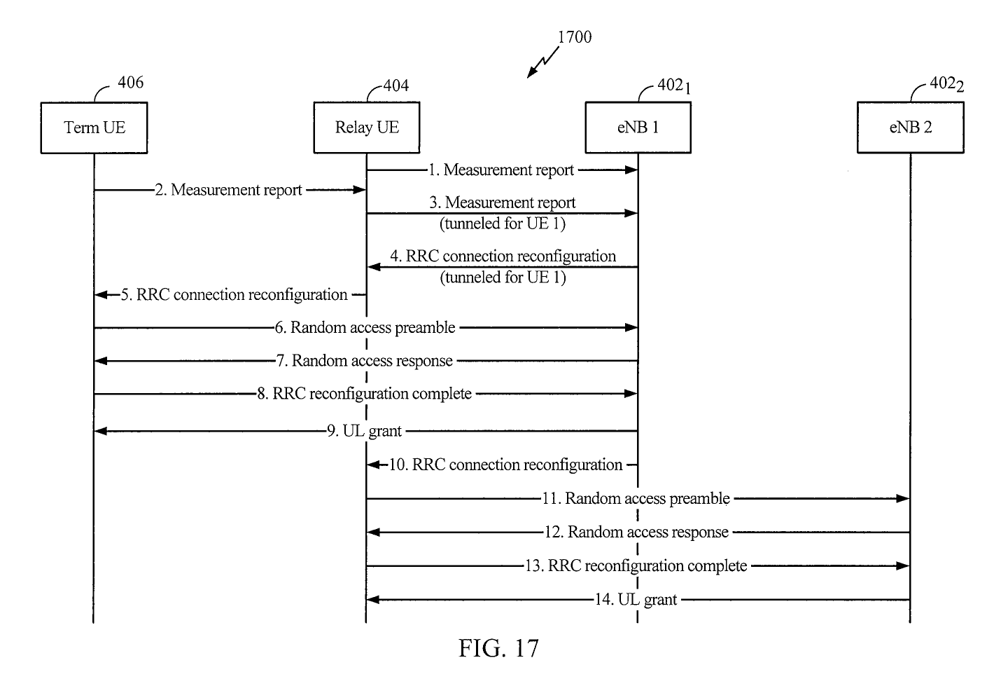

FIG. 17 is a call flow illustrating handover of a terminal UE from a relay UE to a first base station and handover of the relay UE from the first base station to a second base station, according to aspects of the present disclosure. While operations 1-4 are the same as FIG. 16, an RRC reconfiguration message (sent at operation 5), causes the UE 406 to handover to eNB 1, while an RRC reconfiguration message (sent at operation 10), causes the relay UE 404 to handover from eNB 1 to eNB 2.

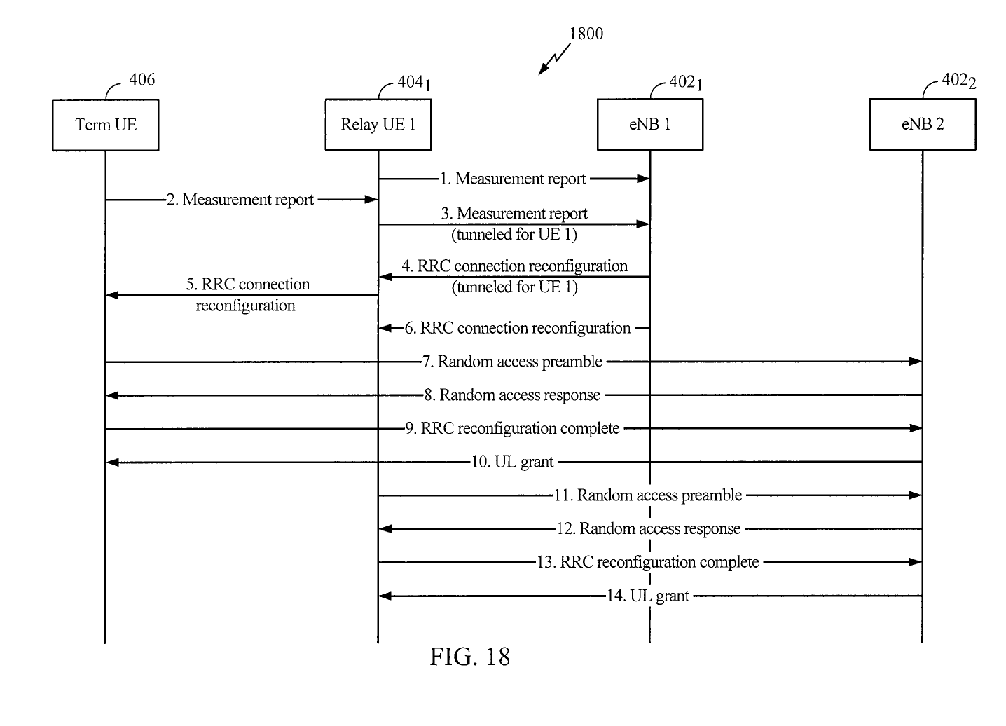

FIG. 18 is a call flow illustrating handover of a relay UE from a first base station to a second base station and handover of a terminal UE from the relay UE to the second base station, according to aspects of the present disclosure. This call flow is similar to the call flow shown in FIG. 17, except that both terminal UE 406 and relay UE are both handed over to eNB 2.

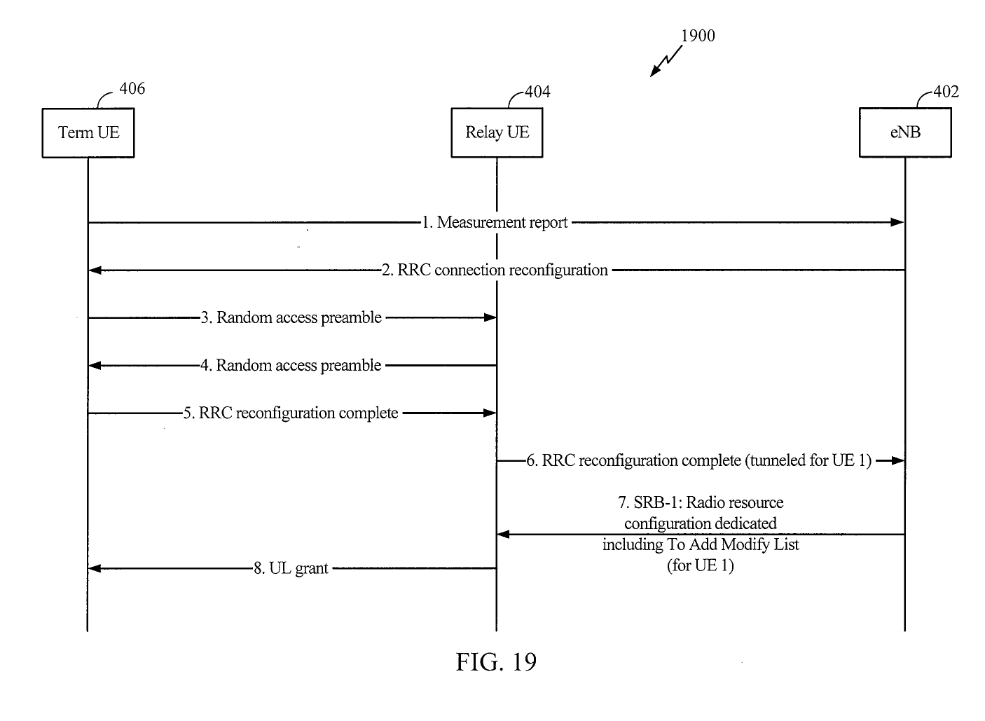

FIG. 19 is a call flow illustrating handover of a terminal UE from a first base station to a relay UE, according to aspects of the present disclosure. In this manner, the relay UE 404 may be introduced into communications between the eNB 402 and the UE 406, such that coverage may be extended as the UE 406 moves away from the eNB 402, for example.

As illustrated, the call flow assumes UE 406 is initially served by eNB 402. After sending a measurement report, an RRC reconfiguration message (sent at operation 2), causes the UE 406 to handover from eNB 402 to relay UE 404. Subsequent operations 5-8 correspond to similar operations shown in other figures, such as operations 7-10 of FIG. 14.

FIG. 20 is a call flow illustrating initial access of a relay UE with a base station in a carrier aggregation mode, according to aspects of the present disclosure. As illustrated, the operations for initial access shown in FIG. 20 may be similar to those shown in FIG. 13 (for single carrier mode) but RRC connection reconfiguration and RRC connection reconfiguration complete messages are exchanged directly between the eNB 402 and UE 406.

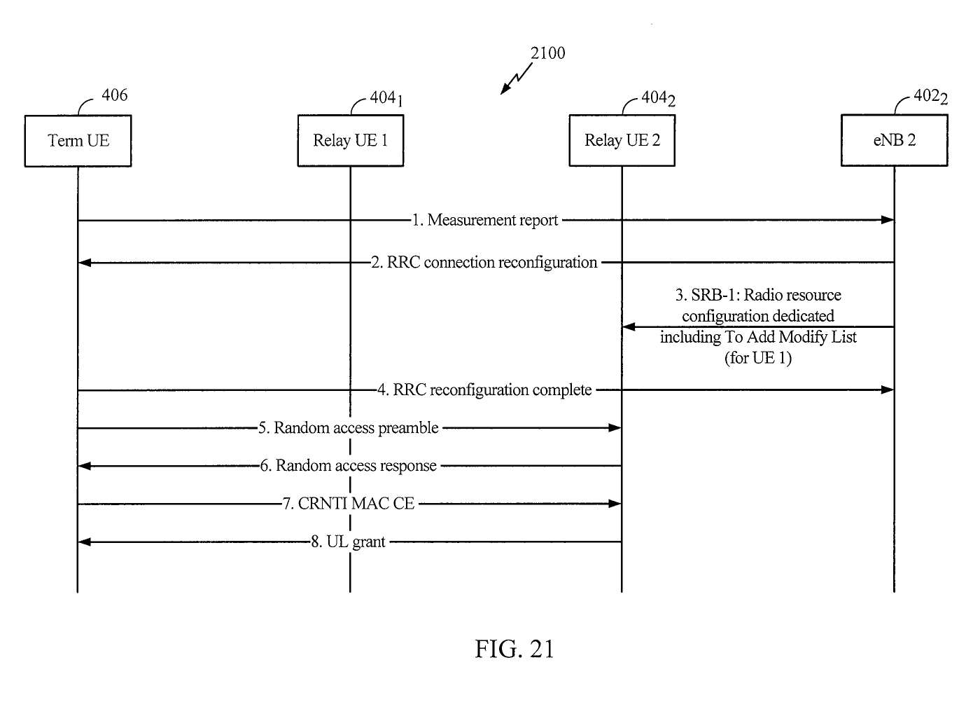

FIG. 21 is a call flow illustrating handover of a terminal UE between relay UEs served by a common base station in a carrier aggregation mode, according to aspects of the present disclosure. As illustrated, the operations shown in FIG. 21 may be similar to those shown in FIG. 14 (for single carrier mode handover between UE relays) but the measurement report, RRC connection reconfiguration and RRC connection reconfiguration complete messages are exchanged directly between the eNB 402 and UE 406, rather than tunneled through a relay UE.

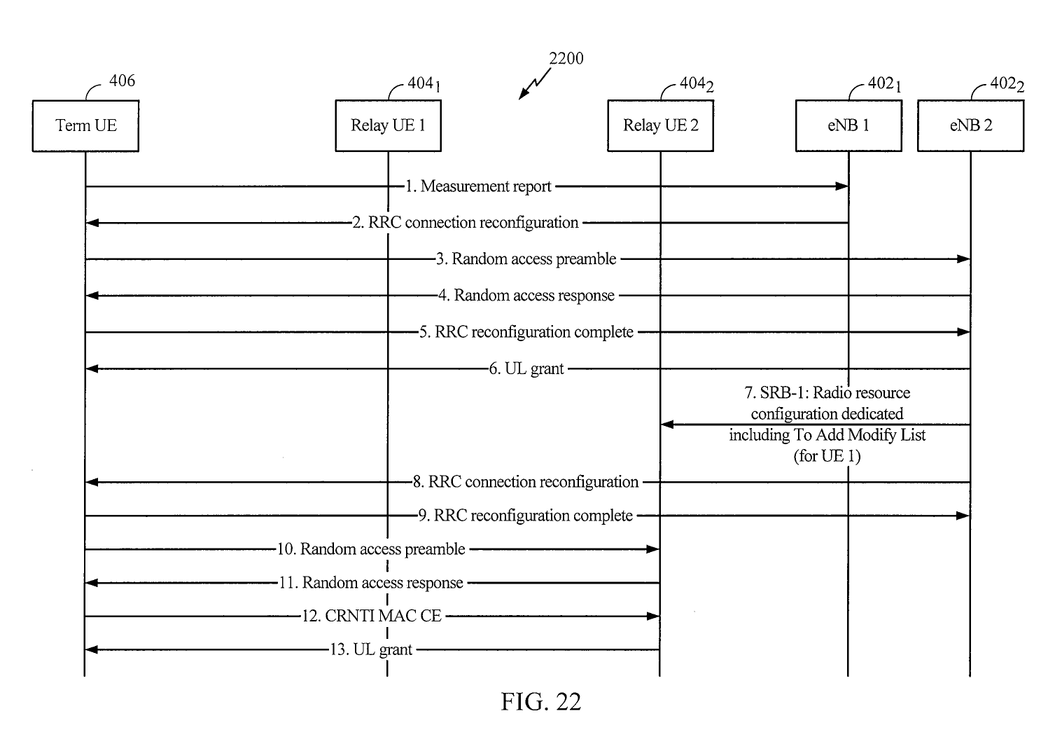

FIG. 22 is a call flow illustrating handover of a terminal UE between relay UEs served by different base stations in a carrier aggregation mode, according to aspects of the present disclosure. As illustrated, the operations shown in FIG. 22 may be similar to those shown in FIG. 15 (for single carrier mode handover between UE relays served by different eNBs) but the measurement report, RRC connection reconfiguration and RRC connection reconfiguration complete messages are exchanged directly between the terminal UE 406 and the eNBs.

In addition, terminal UE may perform random access procedures with the target eNB2, before performing random access procedures with the target relay UE 2. In this manner, eNB 2 and relay UE 2 may both serve the terminal UE (e.g., on different frequencies or on the same frequency via TDM) as discussed above.

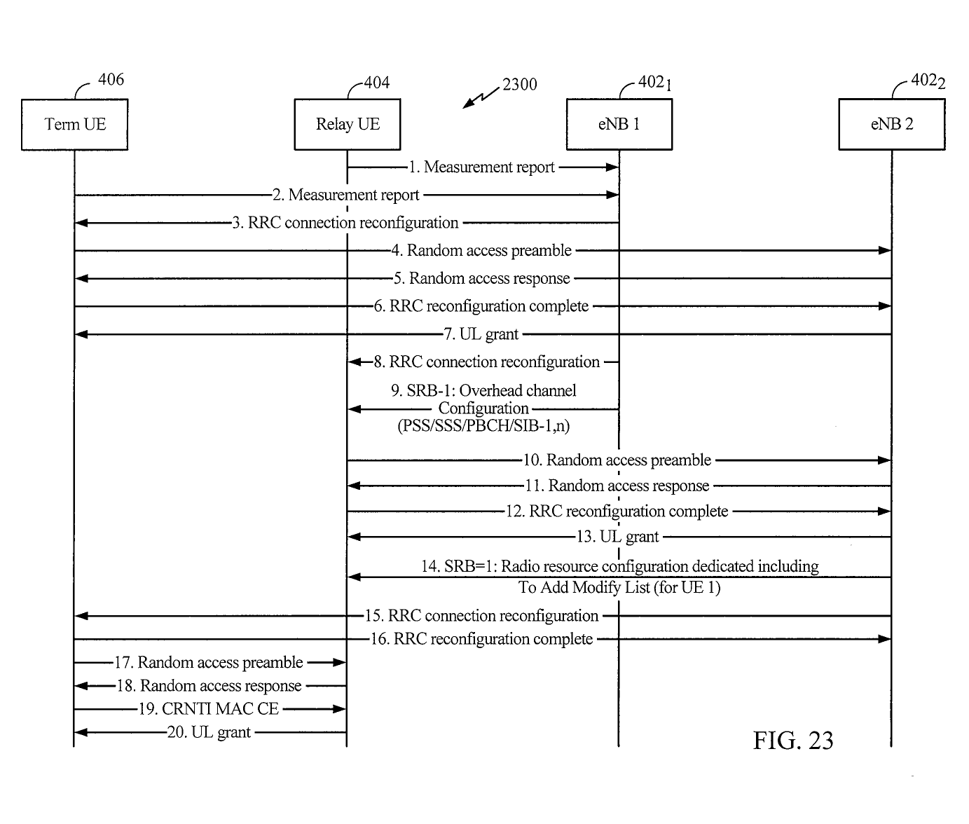

FIG. 23 is a call flow illustrating handover of a relay UE between different base stations in a carrier aggregation mode, according to aspects of the present disclosure. As illustrated, the operations shown in FIG. 23 may be similar to those shown in FIG. 16 (for single carrier mode handover of a relay UE between eNBs) but the UE measurement report, RRC connection reconfiguration and RRC connection reconfiguration complete messages may be exchanged directly between the terminal UE 406 and the current and targeted eNBs involved in handover of the relay UE 404.

In the above-described carrier aggregation deployments of relay UEs, similar operations may be performed when handing over a terminal UE between eNBs and relay UEs, as when adding/removing secondary cells (SCells) or changing primary cells (PCells) in carrier aggregation scenarios.

For example, for a backward handover from the relay UE 404 to the first eNB 402₁ for communications involving the UE 406 and a handover of the relay UE 404 from the first eNB 402₁ to the second eNB 402₂, the UE 406 may use a similar or same call flow as removal of an SCell for carrier aggregation. For example, a relay UE 404 may use an LTE Rel 8 handover procedure followed by configuration of relay UE overhead information.

For a backward handover from the relay UE 404 to the second eNB 402₂ for communications involving the UE 406 and a handover of the relay UE 404 from the first eNB 402₁ to the second eNB 402₂, the UE 406 may use the same call flow as change of PCell. The relay UE 404 may use an LTE Rel 8 handover procedure followed by configuration of relay UE overhead information.

For a backward intra-eNB handover from the eNB 402 to the relay UE 404 for communications with the UE 406 (e.g., to introduce the relay UE 404 into communications between the eNB 402 and the UE 406), the UE may use the same call flow as change of SCell.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may have corresponding counterpart means-plus-function components with similar numbering.

For example, means for transmitting, means for relaying, or means for registering may comprise a transmitter (e.g., a transmitter 222) and/or an antenna 224 of the transmitter system 210 or a transmitter (e.g., a transmitter 254) and/or an antenna 252 of the receiver system 250 illustrated in FIG. 2. Means for receiving or means for registering may comprise a receiver (e.g., a receiver 254) and/or an antenna 252 of the receiver system 250 or a receiver (e.g., a receiver 222) and/or an antenna 224 of the transmitter system 210 illustrated in FIG. 2. Means for processing, means for determining, means for configuring, or means for registering may comprise a processing system, which may include at least one processor, such as the RX data processor 260, the processor 270, and/or the TX data processor 238 of the receiver system 250 or the RX data processor 242, the processor 230, and/or the TX data processor 214 of the transmitter system 210 illustrated in FIG. 2.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications, comprising:
receiving, at a first user equipment (UE) functioning as a relay, data from a first apparatus; and
relaying the data to a second apparatus without interpreting or altering security features of the data.

2. The method of claim 1, wherein the first apparatus comprises an evolved Node B (eNB) and the second apparatus comprises a second UE.

3. The method of claim 1, wherein the first apparatus comprises a second UE and the second apparatus comprises an evolved Node B (eNB).

4. The method of claim 1, wherein a protocol stack for the first UE comprises:
a physical (PHY) layer;
a media access control (MAC) layer disposed above the PHY layer; and
a radio link control (RLC) layer disposed above the MAC layer.

5. The method of claim 4, wherein the relaying is end-to-end between the first and second apparatuses without interception by the first UE for layers of the protocol stack above the RLC layer.

6. The method of claim 4, wherein the first UE is aware of a PHY/MAC/RLC configuration of the second apparatus.

7. The method of claim 4, further comprising configuring a PHY/MAC/RLC configuration for an access link between the first UE and one of the first and second apparatuses.

8. The method of claim 1, wherein the first UE is capable of carrier aggregation.

9. The method of claim 1, wherein the receiving comprises receiving the data from the first apparatus via a first frequency band and wherein the relaying comprises relaying the data to the second apparatus via a second frequency band.

10. The method of claim 9, wherein one of the first and second frequency bands is in an unlicensed spectrum.

11. The method of claim 1, wherein the relaying comprises time division multiplexing (TDM) partitioning with signals sent directly from the first apparatus to the second apparatus.

12. The method of claim 1, further comprising receiving, from the first apparatus, a control signal to activate or deactivate the relaying to the second apparatus.

13. The method of claim 1, further comprising transmitting, to the second apparatus, a control signal directing the second apparatus to tune to the first apparatus.

14. The method of claim 1, further comprising receiving, from the second apparatus, a control signal to stop the relaying to the second apparatus.

15. The method of claim 1, further comprising transmitting, to the first apparatus, a control signal directing the first apparatus to stop sending the data to the first UE.

16. The method of claim 1, further comprising:
determining a parameter; and
registering with the first apparatus as s relay based on the parameter.

17. The method of claim 16, wherein the parameter comprises at least one of a reference signal received quality (RSRQ), a proximity of other UEs, or resource loading.

18. A first user equipment (UE) configured to function as a relay for wireless communications, comprising:
a receiver configured to receive data from a first apparatus; and
a transmitter configured to relay the data to a second apparatus without interpreting or altering security features of the data.

19. The first UE of claim 18, wherein the first apparatus comprises an evolved Node B (eNB) and the second apparatus comprises a second UE.

20. The first UE of claim 18, wherein the first apparatus comprises a second UE and the second apparatus comprises an evolved Node B (eNB).

21. The first UE of claim 18, wherein a protocol stack for the first UE comprises:
a physical (PHY) layer;
a media access control (MAC) layer disposed above the PHY layer; and
a radio link control (RLC) layer disposed above the MAC layer.

22. The first UE of claim 21, wherein the relaying is end-to-end between the first and second apparatuses without interception by the first UE for layers of the protocol stack above the RLC layer.

23. The first UE of claim 21, wherein the first UE is aware of a PHY/MAC/RLC configuration of the second apparatus.

24. The first UE of claim 21, further comprising a processing system for configuring a PHY/MAC/RLC configuration for an access link between the first UE and one of the first and second apparatuses.

25. The first UE of claim 18, wherein the first UE is capable of carrier aggregation.

26. The first UE of claim 18, wherein the receiver is configured to receive the data from the first apparatus via a first frequency band and wherein the transmitter is configured to relay the data to the second apparatus via a second frequency band.

27. The first UE of claim 26, wherein one of the first and second frequency bands is in an unlicensed spectrum.

28. The first UE of claim 18, wherein the relaying comprises time division multiplexing (TDM) partitioning with signals sent directly from the first apparatus to the second apparatus.

29. The first UE of claim 18, wherein the receiver is configured to receive, from the first apparatus, a control signal to activate or deactivate the relaying to the second apparatus.

30. The first UE of claim 18, wherein the transmitter is configured to transmit, to the second apparatus, a control signal directing the second apparatus to tune to the first apparatus.

31. The first UE of claim 18, wherein the receiver is configured to receive, from the second apparatus, a control signal to stop the relaying to the second apparatus.

32. The first UE of claim 18, wherein the transmitter is configured to transmit, to the first apparatus, a control signal directing the first apparatus to stop sending the data to the first UE.

33. The first UE of claim 18, further comprising a processing system configured to:
determine a parameter; and
register with the first apparatus as the relay based on the parameter.

34. The first UE of claim 33, wherein the parameter comprises at least one of a reference signal received quality (RSRQ), a proximity of other UEs, or resource loading.

35. A first user equipment (UE) functioning as a relay for wireless communications, comprising:
means for receiving data from a first apparatus; and
means for relaying the data to a second apparatus without interpreting or altering security features of the data.

36. The first UE of claim 35, wherein the first apparatus comprises an evolved Node B (eNB) and the second apparatus comprises a second UE.

37. The first UE of claim 35, wherein the first apparatus comprises a second UE and the second apparatus comprises an evolved Node B (eNB).

38. The first UE of claim 35, wherein a protocol stack for the first UE comprises:
a physical (PHY) layer;
a media access control (MAC) layer disposed above the PHY layer; and
a radio link control (RLC) layer disposed above the MAC layer.

39. The first UE of claim 38, wherein the relaying is end-to-end between the first and second apparatuses without interception by the first UE for layers of the protocol stack above the RLC layer.

40. The first UE of claim 38, wherein the first UE is aware of a PHY/MAC/RLC configuration of the second apparatus.

41. The first UE of claim 38, further comprising means for configuring a PHY/MAC/RLC configuration for an access link between the first UE and one of the first and second apparatuses.

42. The first UE of claim 35, wherein the first UE is capable of carrier aggregation.

43. The first UE of claim 35, wherein the means for receiving is configured to receive the data from the first apparatus via a first frequency band and wherein the means for relaying is configured to relay the data to the second apparatus via a second frequency band.

44. The first UE of claim 43, wherein one of the first and second frequency bands is in an unlicensed spectrum.

45. The first UE of claim 35, wherein the relaying comprises time division multiplexing (TDM) partitioning with signals sent directly from the first apparatus to the second apparatus.

46. The first UE of claim 35, wherein the means for receiving is configured to receive, from the first apparatus, a control signal to activate or deactivate the relaying to the second apparatus.

47. The first UE of claim 35, further comprising means for transmitting, to the second apparatus, a control signal directing the second apparatus to tune to the first apparatus.

48. The first UE of claim 35, wherein the means for receiving is configured to receive, from the second apparatus, a control signal to stop the relaying to the second apparatus.

49. The first UE of claim 35, further comprising means for transmitting, to the first apparatus, a control signal directing the first apparatus to stop sending the data to the first UE.

50. The first UE of claim 35, further comprising:
means for determining a parameter; and
means for registering with the first apparatus as the relay based on the parameter.

51. The first UE of claim 50, wherein the parameter comprises at least one of a reference signal received quality (RSRQ), a proximity of other UEs, or resource loading.

52. A computer-program product for wireless communications, comprising:
a computer-readable medium comprising code for:
receiving, at a first user equipment (UE) functioning as a relay, data from a first apparatus; and
relaying the data to a second apparatus without interpreting or altering security features of the data.

53. The computer-program product of claim 52, wherein the first apparatus comprises an evolved Node B (eNB) and the second apparatus comprises a second UE.

54. The computer-program product of claim 52, wherein the first apparatus comprises a second UE and the second apparatus comprises an evolved Node B (eNB).

55. The computer-program product of claim 52, wherein a protocol stack for the first UE comprises:
a physical (PHY) layer;
a media access control (MAC) layer disposed above the PHY layer; and
a radio link control (RLC) layer disposed above the MAC layer.

56. The computer-program product of claim 55, wherein the relaying is end-to-end between the first and second apparatuses without interception by the first UE for layers of the protocol stack above the RLC layer.

57. The computer-program product of claim 55, wherein the first UE is aware of a PHY/MAC/RLC configuration of the second apparatus.

58. The computer-program product of claim 55, further comprising code for configuring a PHY/MAC/RLC configuration for an access link between the first UE and one of the first and second apparatuses.

59. The computer-program product of claim 52, wherein the first UE is capable of carrier aggregation.

60. The computer-program product of claim 52, wherein the receiving comprises receiving the data from the first apparatus via a first frequency band and wherein the relaying comprises relaying the data to the second apparatus via a second frequency band.

61. The computer-program product of claim 60, wherein one of the first and second frequency bands is in an unlicensed spectrum.

62. The computer-program product of claim 52, wherein the relaying comprises time division multiplexing (TDM) partitioning with signals sent directly from the first apparatus to the second apparatus.

63. The computer-program product of claim 52, further comprising code for receiving, from the first apparatus, a control signal to activate or deactivate the relaying to the second apparatus.

64. The computer-program product of claim 52, further comprising code for transmitting, to the second apparatus, a control signal directing the second apparatus to tune to the first apparatus.

65. The computer-program product of claim 52, further comprising code for receiving, from the second apparatus, a control signal to stop the relaying to the second apparatus.

66. The computer-program product of claim 52, further comprising code for transmitting, to the first apparatus, a control signal directing the first apparatus to stop sending the data to the first UE.

67. The computer-program product of claim 52, further comprising code for:
determining a parameter; and
registering with the first apparatus as the relay based on the parameter.

68. The computer-program product of claim 67, wherein the parameter comprises at least one of a reference signal received quality (RSRQ), a proximity of other UEs, or resource loading.
